(19) United States
(12) Patent Application Publication
(10) Pub. No.: US 2019/0387251 A1
(43) Pub. Date: Dec. 19, 2019

(54) Methods and Apparatuses of Video Processing with Overlapped Block Motion Compensation in Video Coding Systems

(71) Applicant: MEDIATEK INC., Hsin-Chu (TW)

(72) Inventors: Zhi-Yi LIN, Hsinchu (TW); Tzu-Der CHUANG, Hsinchu (TW); Ching-Yeh CHEN, Hsinchu (TW); Chih-Wei HSU, Hsinchu (TW); Chen-Yen LAI, Hsinchu (TW); Yu-Wen HUANG, Hsinchu (TW)

(21) Appl. No.: 16/444,078

(22) Filed: Jun. 18, 2019

Related U.S. Application Data
(60) Provisional application No. 62/695,301, filed on Jul. 9, 2018.
(60) Provisional application No. 62/691,657, filed on Jun. 29, 2018.
(60) Provisional application No. 62/686,741, filed on Jun. 19, 2018.

(51) Int. Cl. H04N 19/583; H04N 19/159; H04N 19/132; H04N 19/105; H04N 19/43; H04N 19/176; H04N 19/186

(52) U.S. Cl. CPC H04N 19/583; H04N 19/159; H04N 19/132; H04N 19/186; H04N 19/43; H04N 19/176; H04N 19/105

(57) ABSTRACT

Exemplary video processing methods and apparatuses for coding a current block determine a number of OBMC blending lines for a boundary between a current block and a neighboring block according to motion information, a location of the current block, or a coding mode of the current block. OBMC is applied to the current block by blending an original predictor of the current block with an OBMC predictor for the number of OBMC blending lines. Some other exemplary video processing methods and apparatuses for coding a current block extend reference samples fetched from a buffer by a padding method to generate padded sample, and OBMC is applied to the current block or a neighboring block by blending an original predictor with an OBMC predictor generated from the extended reference samples.

### CROSS REFERENCE TO RELATED APPLICATION′

The present invention claims priority to U.S. Provisional Patent Application, Ser. No. 62/686,741, filed on Jun. 19, 2018, entitled “Methods of Overlapped Block Motion Compensation”, U.S. Provisional Patent Application, Ser. No. 62/691,657, filed on Jun. 29, 2018, entitled “Methods of Overlapped Block Motion Compensation”, and U.S. Provisional Patent Application, Ser. No. 62/695,301, filed on Jul. 9, 2018, entitled “Methods of Bandwidth Reduction for Overlapped Blocks Motion Compensation”. The U.S. Provisional patent applications are hereby incorporated by reference in their entireties.

### FIELD OF THE INVENTION

The present invention relates to video processing methods and apparatuses in video encoding or decoding systems. In particular, the present invention relates to bandwidth reduction for processing video data with Overlapped Block Motion Compensation (OBMC).

### BACKGROUND AND RELATED ART

The High-Efficiency Video Coding (HEVC) standard is the latest video coding standard developed by the Joint Collaborative Team on Video Coding (JCT-VC) group of video coding experts from ITU-T Study Group. The HEVC standard improves the video compression performance of its proceeding standard H.264/AVC to meet the demand for higher picture resolutions, higher frame rates, and better video qualities. During development of the HEVC standard, Overlapped Block Motion Compensation (OBMC) was proposed to improve coding efficiency by blending an original predictor with OBMC predictors derived from neighboring motion information.

OBMC The fundamental principle of OBMC finds a Linear Minimum Mean Squared Error (LMMSE) estimate of a pixel intensity value based on motion compensated signals derived from its nearby block Motion Vectors (MVs). From estimation-theoretic perspective, these MVs are regarded as different plausible hypotheses for its true motion, and to maximize coding efficiency, the weights for the MVs are determined to minimize the mean squared prediction error subject to the unit-gain constraint. OBMC was proposed to improve visual quality of reconstructed video while provide coding gain for boundaries pixels. If two different MVs are used for motion compensation of two regions, pixels at the partition boundary of the two regions typically have large discontinuities and result in visual artifacts such as block artifacts. These discontinuities decrease the transform efficiency. In an example of applying OBMC to a geometry partition, two regions created by the geometry partition are denoted as region 1 and region 2, a pixel from region 1 is defined as a boundary pixel if any of its four connected neighboring pixels (i.e. left, top, right, and bottom pixels) belongs to region 2, and a pixel from region 2 is defined as a boundary pixel if any of its four connected neighboring pixels belongs to region 1. FIG. 1 illustrates an example of boundary pixels between two regions of a block. Grey-shaded pixels 122 belong to the boundary of a first region 12 at the top-left half of the block, and white-shaded pixels 142 belong to the boundary of a second region 14 at the bottom-right half of the block. For each boundary pixel, motion compensation is performed using a weighted sum of motion predictors derived according to the MVs of the first region 12 and second region 14. The weights are ¾ for the predictor derived using the MV of the region containing the boundary pixel and ¼ for the predictor derived using the MV of the other region.

OBMC is also used to smooth boundary pixels of symmetrical motion partitions such as two 2N×N or N×2N Prediction Units (PUs) partitioned from a 2N×2N Coding Unit (CU). OBMC is applied to the horizontal boundary of two 2N×N PUs and the vertical boundary of two N×2N PUs. Pixels at the partition boundary may have large discontinuities as partitions are reconstructed using different MVs, OBMC is applied to alleviate visual artifacts and improve transform and coding efficiency. FIG. 2A demonstrates an example of applying OBMC to two 2N×N blocks and FIG. 2B demonstrates an example of applying OBMC to two N×2N blocks. Grey pixels in FIG. 2A or FIG. 2B are pixels belonging to Partition 0 and white pixels are pixels belonging to Partition 1. In this example, the overlapped region in a luminance (luma) component is defined as two rows of pixels on each side of the horizontal boundary and two columns of pixels on each side of the vertical boundary. For pixels which are one row or one column apart from the partition boundary, i.e. pixels labeled as A in FIG. 2A and FIG. 2B, OBMC weighting factors are (¾, ¼) for the original predictor and OBMC predictor respectively. For pixels which are two rows or two columns apart from the partition boundary, i.e., pixels labeled as B in FIG. 2A and FIG. 2B, OBMC weighting factors are (⅞, ⅛) for the original predictor and OBMC predictor respectively. For chrominance (chroma) components, the overlapped region in this example is defined as one row of pixel on each side of the horizontal boundary and one column of pixel on each side of the vertical boundary, and the weighting factors are (¾, ¼) for the original predictor and OBMC predictor respectively.

Skip and Merge

Skip and Merge modes were proposed and adopted in the HEVC standard to increase the coding efficiency of motion information by inheriting the motion information from a spatially neighboring block or a temporally collocated block. To code a PU in Skip or Merge mode, instead of signaling motion information, only an index representing a final candidate selected from a candidate set is signaled. The motion information reused by the PU coded in Skip or Merge mode includes a motion vector (MV), an inter prediction indicator, and a reference picture index of the selected final candidate. It is noted that if the selected final candidate is a temporal motion candidate, the reference picture index is always set to zero. Prediction residual is coded when the PU is coded in Merge mode, however, the Skip mode further skips signaling of the prediction residual as the residual data of a PU coded in Skip mode is forced to be zero.

FIG. 3 illustrates a Merge candidate set defined in the HEVC standard for a current PU 30. The Merge candidate set consists of four spatial motion candidates associated with neighboring blocks of the current PU 30 and one temporal motion candidate associated with a collocated PU 32 of the current PU 30. As shown in FIG. 3, the first Merge candidate is a left predictor A₁ 312, the second Merge candidate is a top predictor B₁ 314, the third Merge candidate is a right above predictor B₀ 313, and a fourth Merge candidate is a left below predictor A₀ 311. A left above predictor B₂ 315 is included in the Merge candidate set to replace an unavailable spatial predictor. A fifth Merge candidate is a temporal predictor of first available temporal predictors T_{BR} 321 and T_{CTR} 322. The encoder selects one final candidate from the Merge candidate set for each PU coded in Skip or Merge mode based on motion vector competition such as through a Rate-Distortion Optimization (RDO) decision, and an index representing the selected final candidate is signaled to the decoder. The decoder selects the same final candidate from the candidate set according to the index transmitted in the video bitstream. Since the derivations of Skip and Merge candidates are similar, the “Merge” mode referred hereafter may correspond to Merge mode as well as Skip mode for convenience.

Sub-block motion compensation is employed in many recently developed coding tools such as subblock Temporal Motion Vector Prediction (sbTMVP), Spatial-Temporal Motion Vector Prediction (STMVP), Pattern-based Motion Vector Derivation (PMVD), and Affine Motion Compensation Prediction (MCP) to increase the accuracy of the prediction process. A CU or a PU coded by sub-block motion compensation is divided into multiple sub-blocks, and these sub-blocks within the CU or PU may have different reference pictures and different MVs. A high bandwidth is therefore demanded for blocks coded in sub-block motion compensation especially when MVs of each sub-block are very diverse. Some of the sub-block motion compensation coding tools are described in the following.

SbTMVP Subblock Temporal Motion Vector Prediction (Subblock TMVP, SbTMVP) is applied to the Merge mode by including at least one SbTMVP candidate as a candidate in the Merge candidate set. SbTMVP is also referred to as Alternative Temporal Motion Vector Prediction (ATMVP). A current PU is partitioned into smaller sub-PUs, and corresponding temporal collocated motion vectors of the sub-PUs are searched. An example of the SbTMVP technique is illustrated in FIG. 4, where a current PU 41 of size M×N is divided into (M/P)×(N/Q) sub-PUs, each sub-PU is of size P×Q, where M is divisible by P and N is divisible by Q. The detail algorithm of the SbTMVP mode may be described in three steps as follows.

In step 1, an initial motion vector is assigned for the current PU 41, denoted as vec_init. The initial motion vector is typically the first available candidate among spatial neighboring blocks. For example, List X is the first list for searching collocated information, and vec_init is set to List X MV of the first available spatial neighboring block, where X is 0 or 1. The value of X (0 or 1) depends on which list is better for inheriting motion information, for example, List 0 is the first list for searching when the Picture Order Count (POC) distance between the reference picture and current picture is closer than the POC distance in List 1. List X assignment may be performed at slice level or picture level. After obtaining the initial motion vector, a “collocated picture searching process” begins to find a main collocated picture, denoted as main_colpic, for all sub-PUs in the current PU. The reference picture selected by the first available spatial neighboring block is first searched, after that, all reference pictures of the current picture are searched sequentially. For B-slices, after searching the reference picture selected by the first available spatial neighboring block, the search starts from a first list (List 0 or List 1) reference index 0, then index 1, then index 2, until the last reference picture in the first list, when the reference pictures in the first list are all searched, the reference pictures in a second list are searched one after another. For P-slice, the reference picture selected by the first available spatial neighboring block is first searched; followed by all reference pictures in the list starting from reference index 0, then index 1, then index 2, and so on. During the collocated picture searching process, “availability checking” checks the collocated sub-PU around the center position of the current PU pointed by vec_init_scaled is coded by an inter or intra mode for each searched picture. Vec_init_scaled is the MV with appropriated MV scaling from vec_init. Some embodiments of determining “around the center position” are a center pixel (M/2, N/2) in a PU size M×N, a center pixel in a center sub-PU, or a mix of the center pixel or the center pixel in the center sub-PU depending on the shape of the current PU. The availability checking result is true when the collocated sub-PU around the center position pointed by vec_init_scaled is coded by an inter mode. The current searched picture is recorded as the main collocated picture main_colpic and the collocated picture searching process finishes when the availability checking result for the current searched picture is true. The MV of the around center position is used and scaled for the current block to derive a default MV if the availability checking result is true. If the availability checking result is false, that is when the collocated sub-PU around the center position pointed by vec_init_scaled is coded by an intra mode, it goes to search a next reference picture. MV scaling is needed during the collocated picture searching process when the reference picture of vec_init is not equal to the original reference picture. The MV is scaled depending on temporal distances between the current picture and the reference picture of vec_init and the searched reference picture, respectively. After MV scaling, the scaled MV is denoted as vec_init_scaled.

In step 2, a collocated location in main_colpic is located for each sub-PU. For example, corresponding location 421 and location 422 for sub-PU 411 and sub-PU 412 are first located in the temporal collocated picture 42 (main_colpic). The collocated location for a current sub-PU i is calculated in the following:

collocated location x=Sub-PU_i_x+vec_init_scaled_i_x(integer part)+shift_x,

collocated location y=Sub-PU_i_y+vec_init_scaled_i_y(integer part)+shift_y,

where Sub-PU_i_x represents a horizontal left-top location of sub-PU i inside the current picture, Sub-PU_i_y represents a vertical left-top location of sub-PU i inside the current picture, vec_init_scaled_i_x represents a horizontal component of the scaled initial motion vector for sub-PU i (vec_init_scaled_i), vec_init_scaled_i_y represents a vertical component of vec_init_scaled_i, and shift_x and shift_y represent a horizontal shift value and a vertical shift value respectively. To reduce the computational complexity, only integer locations of Sub-PU_i_x and Sub-PU_i_y, and integer parts of vec_init_scaled_i_x, and vec_init_scaled_i_y are used in the calculation. In FIG. 4, the collocated location 425 is pointed by vec_init_sub_0 423 from location 421 for sub-PU 411 and the collocated location 426 is pointed by vec_init_sub_1 424 from location 422 for sub-PU 412.

In step 3 of the SbTMVP mode, Motion Information (MI) for each sub-PU, denoted as SubPU_MI_i, is obtained from collocated_picture_i_L0 and collocated_picture_i_L1 on collocated location x and collocated location y. MI is defined as a set of {MV_x, MV_y, reference lists, reference index, and other merge-mode-sensitive information, such as a local illumination compensation flag}. Moreover, MV_x and MV_y may be scaled according to the temporal distance relation between a collocated picture, current picture, and reference picture of the collocated MV. If MI is not available for some sub PU, MI of a sub PU around the center position will be used, or in another word, the default MV will be used. As shown in FIG. 4, subPU0_MV 427 obtained from the collocated location 425 and subPU1_MV 428 obtained from the collocated location 426 are used to derive predictors for sub-PU 411 and sub-PU 412 respectively. Each sub-PU in the current PU 41 derives its own predictor according to the MI obtained on corresponding collocated location.

STMVP In JEM-3.0, a Spatial-Temporal Motion Vector Prediction (STMVP) technique is used to derive a new candidate to be included in a candidate set for Skip or Merge mode. Motion vectors of sub-blocks are derived recursively following a raster scan order using temporal and spatial motion vector predictors. FIG. 5 illustrates an example of one CU with four sub-blocks and its neighboring blocks for deriving a STMVP candidate. The CU in FIG. 5 is 8×8 containing four 4×4 sub-blocks, A, B, C and D, and neighboring N×N blocks in the current picture are labeled as a, b, c, and d. The STMVP candidate derivation for sub-block A starts by identifying its two spatial neighboring blocks. The first neighboring block c is a N×N block above sub_block A, and the second neighboring block b is a N×N block to the left of the sub-block A. Other N×N block above sub-block A, from left to right, starting at block c, are checked if block c is unavailable or block c is intra coded. Other N×N block to the left of sub-block A, from top to bottom, starting at block b, are checked if block b is unavailable or block b is intra coded. Motion information obtained from the two neighboring blocks for each list are scaled to a first reference picture for a given list. A Temporal Motion Vector Predictor (TMVP) of sub-block A is then derived by following the same procedure of TMVP derivation as specified in the HEVC standard. Motion information of a collocated block at location D is fetched and scaled accordingly. Finally, all available motion vectors are averaged separately for each reference list. The averaged motion vector is assigned as the motion vector of the current sub-block.

PMVD A Pattern-based MV Derivation (PMVD) method, also referred as FRUC (Frame Rate Up Conversion) or DMVR (Decoder-side MV Refinement), consists of bilateral matching for bi-prediction blocks and template matching for uni-prediction blocks. A FRUC_mrg_flag is signaled when Merge or Skip flag is true, and if FRUC_mrg_flag is true, a FRUC_merge_mode is signaled to indicate whether the bilateral matching Merge mode or template matching Merge mode is selected. Both bilateral matching Merge mode and template matching Merge mode consist of two-stage matching: the first stage is PU-level matching, and the second stage is sub-PU-level matching. In the PU-level matching, multiple initial MVs in LIST_0 and LIST_1 are selected respectively. These MVs includes MVs from Merge candidates (i.e., conventional Merge candidates such as these specified in FIG. 3) and MVs from temporal derived MVPs. Two different starting MV sets are generated for two lists. For each MV in one list, a MV pair is generated by composing of this MV and the mirrored MV that is derived by scaling the MV to the other list. For each MV pair, two reference blocks are compensated by using this MV pair. The Sum of Absolutely Differences (SAD) of these two blocks is calculated. The MV pair with the smallest SAD is selected as the best MV pair. Then a diamond search is performed to refine the MV pair. The refinement precision is ⅛-pel. The refinement search range is restricted within ±8 pixels. The final MV pair is the PU-level derived MV pair.

The sub-PU-level searching in the second stage searches a best MV pair for each sub-PU. The current PU is divided into sub-PUs, where the depth of sub-PU is signaled in Sequence Parameter Set (SPS) with a minimum sub-PU size of 4×4. Several starting MVs in List 0 and List 1 are selected for each sub-PU, which includes PU-level derived MV pair, zero MV, HEVC collocated TMVP of the current sub-PU and bottom-right block, temporal derived MVP of the current sub-PU, and MVs of left and above PUs or sub-PUs. By using the similar mechanism in PU-level searching, the best MV pair for each sub-PU is selected. Then a diamond search is performed to refine the best MV pair. Motion compensation for each sub-PU is then performed to generate a predictor for each sub-PU.

For template matching Merge mode, reconstructed pixels of above 4 rows and left 4 columns are used to form a template, and a best matched template with its corresponding MV are derived. In the PU-level matching, several starting MVs in LIST 0 and LIST 1 are selected respectively. These starting MVs include the MVs from Merge candidates and MVs from temporal derived MVPs. Two different starting MV sets are generated for two lists. For each MV in one list, a SAD cost of the template with the MV is calculated, and the MV with the minimum cost is the best MV. A diamond search is performed to refine the MV with a refinement precision of ⅛-pel. The final MV is the PU-level derived MV. The MVs in LIST 0 and LIST 1 are generated independently. For the sub-PU-level searching, the current PU is divided into multiple sub-PUs, and several starting MVs in LIST 0 and LIST1 are selected for each sub-PU at left or top PU boundaries. The starting MVs include MVs of PU-level derived MV, zero MV, HEVC collocated TMVP of the current sub-PU and bottom-right block, temporal derived MVP of the current sub-PU, and MVs of the left and above PUs/sub-PUs. A best MV pair for each sub-PU is selected by using a similar mechanism in the PU-level searching. A diamond search is performed to refine the best MV pair. Motion compensation is applied to generate a predictor for each sub-PU. For those PUs not at left or top PU boundaries, the second stage, sub-PU-level searching is not applied, and corresponding MVs are set equal to the MVs derived in the first stage.

Affine MCP

Affine Motion Compensation Prediction (Affine MCP) is a technique developed for predicting various types of motion other than the translation motion. For example, rotation, zoom in, zoom out, perspective motions and other irregular motions. An exemplary simplified affine transform MCP as shown in FIG. 6A is applied in JEM-3.0 to improve the coding efficiency. An affine motion field of a current block 61 is described by motion vectors 613 and 614 of two control points 611 and 612. The Motion Vector Field (MVF) of a block is described by the following equations:

$$\{ \begin{matrix}{v}_{x} = \frac{( {v}_{1 x} - {v}_{0 x} )}{w} x - \frac{( {v}_{1 y} - {v}_{0 y} )}{w} y + {v}_{0 x} \\ {v}_{y} = \frac{( {v}_{1 y} - {v}_{0 y} )}{w} x + \frac{( {v}_{1 x} - {v}_{0 x} )}{w} y + {v}_{0 y}\end{matrix}$$

Where (v₀ₓ, v_{0y}) represents the motion vector 613 of the top-left corner control point 611, and (v₁ₓ, v_{1y}) represents the motion vector 614 of the top-right corner control point 612.

A block based affine transform prediction is applied instead of pixel based affine transform prediction in order to further simplify the affine motion compensation prediction. FIG. 6B illustrates partitioning a current block 62 into sub-blocks and affine MCP is applied to each sub-block. As shown in FIG. 6B, a motion vector of a center sample of each 4×4 sub-block is calculated according to the above equation in which (v₀ₓ, v_{0y}) represents the motion vector 623 of the top-left corner control point 621, and (v₁ₓ, v_{1y}) represents the motion vector 624 of the top-right corner control point 622, and then rounded to 1/16 fraction accuracy. Motion compensation interpolation is applied to generate a predictor for each sub-block according to the derived motion vector. After performing motion compensation prediction, the high accuracy motion vector of each sub-block is rounded and stored with the same accuracy as a normal motion vector.

Bidirectional Optical Flow (BDOF)

BDOF utilizes the assumptions of optical flow and steady motion to achieve the sample-level motion refinement. BDOF is only applied for truly bi-directional predicted blocks, which is predicted from one previous frame and one subsequent frame. In one example of BDOF, a 5×5 window is used to derive motion refinement of each sample, so for an N×N current block, motion compensation results and corresponding gradient information of a (N+4)×(N+4) block are required to derive sample-based motion refinement of the N×N current block. In this example, a 6-Tap gradient filter and a 6-tap interpolation filter are used to generate the gradient information in BDOF. The computation complexity of BDOF is much higher than that of the traditional bi-directional prediction.

If OBMC is performed after normal Motion Compensation (MC), BDOF is separately applied in these two MC processes. BDOF is applied to refine MC results generated by OBMC and MC results generated by normal MC. The redundant OBMC and BDOF processes may be skipped when two neighboring MVs are the same. However, the required bandwidth and MC operations for the overlapped region is increased compared to integrating the OBMC process into the normal MC process. Since fractional-pixel motion vectors are supported in newer coding standards, additional reference pixels around the reference block are fetched from a buffer according to the number of interpolation taps for interpolation calculations. For example, a current PU size is 16×8, an overlapped region is 16×2, and the interpolation filter in MC is 8-Tap. A total number of (16+7)×(8+7)+(16+7)×(2+7)=522 reference pixels per reference list is required for the current PU and the related OBMC if OBMC is performed after normal MC. Only (16+7)×(8+2+7)=391 reference pixels per reference list are required for the current PU and the related OBMC if the OBMC operations are combined with normal MC into one stage. Several methods described in the following are proposed to reduce the computation complexity or memory bandwidth of BDOF when BDOF and OBMC are enabled simultaneously.

Perform OBMC at Sub-Block Level

A CU or a PU is divided into multiple sub-blocks when coded in one of the sub-block motion compensation coding tools, and these sub-blocks may have different reference pictures and different MVs. OBMC may be adaptively switch on and off according to a syntax element at the CU level, and when a CU is subjected to OBMC processing, OBMC is applied to both luma and chroma components of all Motion Compensation (MC) block boundaries except for the right and bottom boundaries of the CU. A MC block is corresponding to a coding block, so when a CU is coded in one of the sub-block motion compensation coding tools such as affine MCP or FRUC mode, each sub-block of the CU is a MC block. High bandwidth and computational complexity are demanded for sub-block motion compensation and applying OBMC at sub-block level. FIG. 7A illustrates an example of applying OBMC on a CU coded without any sub-block motion compensation mode, whereas FIG. 7B illustrates an example of applying OBMC on a CU coded with a sub-block motion compensation tool. As shown in FIG. 7B, when applying OBMC to a current sub-block, beside current motion vectors, motion vectors of four connected neighboring sub-blocks, if available and are not identical to the current motion vector, are also used to derive a final predictor for the current sub-block. Multiple predictors derived based on multiple motion vectors are blended to generate the final predictor. In FIG. 7A, a final predictor for a current CU is calculated by using weighted sum of a current motion compensated predictor C derived by a current MV, an OBMC predictor A′ derived from a MV of an above neighboring block A, and an OBMC predictor B′ derived from a MV of a left neighboring block B. In FIG. 7B, a final predictor for a current sub-block is calculated by using weighted sum of a current motion compensated predictor C derived by a current MV, an OBMC predictor A′ derived from a MV of an above neighboring block, an OBMC predictor B′ derived from a MV of a left neighboring block, an OBMC predictor D′ derived from a MV of a right sub-block D, and an OBMC predictor E′ derived from a MV of a bottom sub-block E.

An OBMC predictor derived based on a MV of a neighboring block/sub-block is denoted as PN, with N indicating an index for the above, below, left or right neighboring block/sub-block. An original predictor derived based on a MV of a current block/sub-block is denoted as PC. If PN is based on motion information of a neighboring block/sub-block that contains the same motion information as the current block/sub-block, OBMC is not performed from this PN. Otherwise, every sample of PN is added to a corresponding sample in PC. In JEM, four rows or four columns of PN are weighted and added to corresponding four rows or four columns of weighted PC, and weighting factors for the four rows/columns of PN are {¼, ⅛, 1/16, 1/32} and weighting factors for the four rows/columns of PC are {¾, ⅞, 15/16, 31/32} respectively. In cases of applying OBMC to small MC blocks, when a height or width of coding block is equal to 4 or when a CU is coded with sub-CU mode, only two rows or two columns of PN are added to PC, and the weighting factors are {¼, ⅛} and {¾, ⅞} for PN and PC respectively. For PN generated based on motion vectors of a vertically (horizontally) neighboring sub-block, samples in the same row (column) of PN are added to PC with a same weighting factor. The OBMC process generating final predictors by weighted sum is performed one by one sequentially which induces high computation complexity and data dependency.

OBMC may be switched on and off according to a CU level flag when a CU size is less than or equal to 256 luma samples. For CUs with a size larger than 256 luma samples or not coded with AMVP mode, OBMC is applied by default. At the encoder, when OBMC is applied to a CU, its impact is taken into account during the motion estimation stage. OBMC predictors derived by the OBMC process using motion information of the top and left neighboring blocks are used to compensate the top and left boundaries of the original data of the current CU, and then the normal motion estimation process is applied.

Pre-Generation and On-the-Fly

There are two different implementation schemes for integrating OBMC in normal MC: pre-generation and on-the-fly. The first implementation scheme pre-generates OBMC regions and stores OBMC predictors of the OBMC regions in a local buffer for neighboring blocks when processing a current block. The corresponding OBMC predictors are therefore available in the local buffer at the time of processing the neighboring blocks. The second implementation scheme is on-the-fly, where OBMC predictors for a current block are generated just before blending with an original predictor of the current block. For example, when applying OBMC on a current sub-block, OBMC predictors are not yet available in the local buffer, so an original predictor is derived according to the MV of the current sub-block, one or more OBMC predictors are also derived according to MVs of one or more neighboring blocks or sub-blocks, and then the original predictor is blended with the one or more OBMC predictors.

In an example of the first implementation scheme, when performing MC on the above neighboring block A in FIG. 7A, beside fetching the MC results A of the above neighboring block (i.e. an original predictor A of the above neighboring block), the MC results of four additional rows are also fetched as the OBMC predictor A′. The OBMC predictor A′ is stored in the local buffer until applying OBMC on the current block. Similarly, MC results of four additional columns (i.e. the OBMC predictor B′) are fetched together with the MC results B of the left neighboring block when performing MC on the left neighboring block. The OBMC predictor B′ is stored in the local buffer until applying OBMC on the current block. FIG. 8A illustrates blocks derived during motion compensation of a current block containing an original predictor C of the current block, an OBMC predictor B and an OBMC predictor R. When performing MC on the current block, beside the MC results of the current block (i.e. the original predictor C), four additional rows and four additional columns of MC results are required to generate the OBMC predictor B and OBMC predictor R. The OBMC predictor B and OBMC predictor R are stored in buffers for the OBMC process of a bottom neighboring block and a right neighboring block of the current block. FIG. 8B illustrates an example of a big block containing an original predictor C of a current block, an OBMC predictor B, an OBMC predictor R, and an OBMC predictor BR derived during motion compensation of the current block. The OBMC predictor BR in this example is also generated and stored in the buffer during the MC process of the current block.

FIG. 9A illustrates reference samples fetched for generating a predictor of a current block without pre-generating OBMC regions for neighboring blocks. FIG. 9B illustrates reference samples fetched for generating a predictor of a current block as well as OBMC regions for neighboring blocks. The reference samples are located according to the motion information of the current block. For example, the motion information includes one or more motion vectors (i.e. MV1 shown in FIG. 9A and FIG. 9B), a reference picture list, and a reference picture index. In this example, the size of the current block is W×H, a width of a right OBMC region is w′, a height of a bottom OBMC region is h′, and an 8-tap interpolation filter is used for motion compensation. An example of w′ is four pixels and h′ is also four pixels, so in this case, four additional columns are fetched to generate the right OBMC region and four additional rows are fetched to generate the bottom OBMC region. The number of reference samples as shown in FIG. 9A needs to be fetched from the memory is (3+W+4)×(3+H+4) if the current MV (i.e. MV1) is not an integer MV. The number of reference samples as shown in FIG. 9B needs to be fetched from the memory for generating the predictors for the current block and the two OBMC regions increases to (3+W+w′+4)×(3+H+h′+4). The two OBMC regions are stored in a buffer for the OBMC process of right and bottom neighboring blocks. Additional line buffers across Coding Tree Units (CTUs) are required to store the MC results of bottom OBMC regions pre-generated for bottom neighboring blocks in a different CTU row.

### BRIEF SUMMARY OF THE INVENTION

Exemplary video processing methods in a video coding system perform Overlapped Block Motion Compensation (OBMC) with an adaptively determined number of OBMC blending lines. An exemplary video processing method receives input video data associated with a current block in a current picture, determines a number of OBMC blending lines for a boundary between the current block and a neighboring block according to one or a combination of motion information, a location of the current block, and a coding mode of the current block, derives an original predictor and an OBMC predictor for the current block, applies OBMC to the current block by blending the OBMC predictors with the original predictor for the number of OBMC blending lines, and encodes or decodes the current block. The original predictor of the current block is derived by motion compensation using motion information of the current block, and the OBMC predictor in an OBMC region is derived by motion compensation using motion information of the neighboring block.

In some embodiments, the method further comprises comparing a block size of the current block with a block size threshold or a block area threshold, and reducing the number of OBMC blending lines if the block size is less than or equal to the block size threshold or the block area threshold. An example of the default number of OBMC blending lines is 4 for the luminance (luma) component and 2 for the chrominance (chroma) components, and the number of OBMC blending lines is reduced to 2 for the luma component and 1 for the chroma components for small blocks. In some other embodiments, the number of OBMC blending lines is determined according to the motion information of the current block, the neighboring block, or both the current and neighboring block, and the motion information includes one or a combination of a MV, inter direction, reference picture list, reference picture index, and picture order count of a reference picture. For examples, the number of OBMC blending lines is reduced if one or both of the inter direction of the current block and the inter direction of the neighboring block are bi-prediction. In some embodiments, the number of OBMC blending lines for applying OBMC at a horizontal boundary is adaptively determined. In one specific embodiment, the number of OBMC blending lines for applying OBMC at a horizontal boundary is adaptively determined while the number of OBMC blending lines for applying OBMC at a vertical boundary is fixed. In some embodiments, the number of OBMC blending lines for applying OBMC at a vertical boundary is adaptively determined. In one specific embodiment, the number of OBMC blending lines for applying OBMC at a vertical boundary is adaptively determined while the number of OBMC blending lines for applying OBMC at a horizontal boundary is fixed. For example, the number of OBMC blending lines for one or both of a top and bottom boundary is adaptively determined while a number of OBMC blending lines for a left or right boundary is fixed. Some embodiments determine the number of OBMC blending lines according to the location of the current block, and the number of OBMC blending lines is reduced if the current block and the neighboring block are not in a same region. Some examples of the region include Coding Tree Unit (CTU), CTU row, tile, and slice. In one specific example, the number of OBMC blending lines is reduced from 4 to 0 if the current block and the neighboring block are not in the same CTU row. In other words, OBMC is not applied to any CTU row boundary to eliminate the additional line buffers required for storing OBMC predictors for neighboring blocks in a different CTU row. Another embodiment determines the number of OBMC blending lines according to the coding mode of the current block, for example, the number of OBMC blending lines for sub-block OBMC is reduced if the coding mode of the current block is affine motion compensation prediction.

Aspects of the disclosure further provide embodiments of apparatus of processing video data with OBMC in a video coding system. An embodiment of the apparatus comprises one or more electronic circuits configured for receiving input data of a current block in a current picture, adaptively determining a number of OBMC blending lines for a boundary between the current block and a neighboring block, performing OBMC by blending an original predictor of the current block and an OBMC predictor for the number of OBMC blending lines, and encoding or decoding the current block.

Aspects of the disclosure further provide a non-transitory computer readable medium storing program instructions for causing a processing circuit of an apparatus to perform a video processing method to encode or decode a current block with OBMC utilizing an adaptively determined number of OBMC blending lines.

In a variation of the video processing method for processing video data with OBMC, some embodiments of the video processing method receive input video data associated with a current block in a current picture, fetch reference samples from a buffer for processing the current block, extend the reference sample by a padding method to generate padded samples, derive an original predictor of the current block by motion compensation using motion information of the current block, derive an OBMC predictor for the current block by motion compensation using motion information of a neighboring block, apply OBMC to the current block by blending the OBMC predictor with the original predictor of the current block, and encode or decode the current block. The extended reference samples are used to generate one or more OBMC regions in order to reduce a total number of reference samples fetched from the buffer.

A first OBMC implementation scheme pre-generates at least one OBMC region for at least one neighboring block when performing motion compensation for the current block, so the extended reference samples including the fetched reference samples and padded samples are used to generate the original predictor and one or more OBMC regions for one or more neighboring blocks of the current block. The one or more OBMC regions are stored for applying OBMC to the one or more neighboring blocks. In some embodiments of block-level OBMC, the one or more OBMC regions include a right OBMC region and a bottom OBMC region, and the fetched reference samples are extended by padding w′ columns in the right of the fetched reference samples and h′ rows in the bottom of the fetched reference samples, where w′ is a width of the right OBMC region and h′ is a height of the bottom OBMC region. In some other embodiments of sub-block level OBMC, the one or more OBMC regions include a right OBMC region, a left OBMC region, an above OBMC region, and a bottom OBMC region. The fetched reference samples are extended by padding w′ columns in both left and right sides of the fetched reference samples and h′ rows in both above and bottom sides of the fetched reference samples, where w′ is a width of the left or right OBMC region and h′ is a height of the above or bottom OBMC region.

A second OBMC implementation scheme generates both the OBMC predictor and original predictor for the current block at the time of applying OBMC to the current block. The extended reference samples are generated by padding reference samples fetched using the motion information of the neighboring block, and the OBMC predictor in said one more OBMC regions is blended with the original predictor of the current block. The neighboring block is an above neighboring block or a left neighboring block.

Some embodiments of the padding method used to extend the reference samples are replicating, mirroring, and extrapolating. In an implementation example, reference samples having been used by non-OBMC motion compensation are first copied to a temporary buffer, then one or more boundaries of the reference samples are filled by the padded samples generated by the padding method. The size of the extended reference samples is defined to have a dimension sufficient for generating said one or more OBMC regions. In another implementation example, when a padded sample outside of reference samples is required for generating said one or more OBMC regions, one of the reference samples is fetched from the buffer as the required padded sample.

In some embodiments, extending the reference samples by a padding method for generating OBMC regions is not always applied to all blocks in the current picture, for example, it is only applied to luma blocks or it is only applied to chroma blocks. In an embodiment, extending the reference samples for generating OBMC regions is only applied to CU boundary OBMC, sub-block OBMC, or sub-block OBMC and CTU row boundaries. In another embodiment, extending the reference samples by the padding method for generating the OBMC regions is only applied to a vertical direction blending or a horizontal direction blending.

Aspects of the disclosure further provide embodiments of apparatus of processing video data with OBMC in a video coding system. An embodiment of the apparatus comprises one or more electronic circuits configured for receiving input data of a current block in a current picture, fetching reference samples from a buffer for processing the current block, extending the reference samples by a padding method to generate padded samples, deriving an original predictor and an OBMC predictor for the current block, applying OBMC by blending the OBMC predictor with the original predictor, and encoding or decoding the current block. The extended reference samples are used for generating one or more OBMC regions for one or more neighboring block when a pre-generation implementation scheme

Aspects of the disclosure further provide a non-transitory computer readable medium storing program instructions for causing a processing circuit of an apparatus to perform a video processing method to encode or decode a current block utilizing a padding method to extend reference samples for generating one or more OBMC regions. Other aspects and features of the invention will become apparent to those with ordinary skill in the art upon review of the following descriptions of specific embodiments.

### BRIEF DESCRIPTION OF THE DRAWINGS

Various embodiments of this disclosure that are proposed as examples will be described in detail with reference to the following figures, and wherein:

FIG. 1 illustrates an example of overlapped motion compensation for a geometry partition.

FIGS. 2A and 2B illustrate examples of OBMC footprint for 2N×N block and N×2N block with different weightings for boundary pixels.

FIG. 3 illustrates positions of spatial and temporal motion candidates for constructing a Merge candidate set for a block coded in Merge mode according to the HEVC standard.

FIG. 4 illustrates an example of determining sub-block motion vectors for sub-blocks in a current PU according to the SbTMVP technique.

FIG. 5 illustrates an example of determining a Merge candidate for a CU split into four sub-blocks according to the STMVP technique.

FIG. 6A illustrates an example of applying affine motion compensation prediction on a current block with two control points.

FIG. 6B illustrates an example of applying block based affine motion compensation prediction with two control points.

FIG. 7A illustrates an example of applying OBMC to a block without sub-block motion compensation mode.

FIG. 7B illustrates an example of applying OBMC to a block with sub-block motion compensation mode.

FIG. 8A illustrates blocks containing a predictor C for a current block, OBMC predictor B, and OBMC predictor R generated by the motion compensation process of the current block when applying the OBMC pre-generation implementation scheme.

FIG. 8B illustrates a big block containing a predictor C for a current block, OBMC predictor B, OBMC predictor R, and OBMC predictor BR generated by the motion compensation process of the current block when applying the OBMC pre-generation implementation scheme.

FIG. 9A illustrates an example of reference samples required for generating a predictor for a current block using motion information of the current block.

FIG. 9B illustrates an example of reference samples required for generating a predictor for a current block and two OBMC predictors for neighboring blocks according to the OBMC pre-generation implementation scheme.

FIG. 10A illustrates an embodiment of extending reference samples by a padding method for generating a predictor for a current block and two OBMC predictors for two neighboring blocks according to the OBMC pre-generation implementation scheme.

FIG. 10B illustrates an embodiment of extending the reference samples by a padding method for generating a predictor for a current sub-block and four OBMC predictors for four neighboring blocks according to the pre-generation implementation scheme of sub-block OBMC.

FIGS. 11A, 11B, and 11C illustrate an embodiment of extending reference samples required for an on-the-fly implementation scheme of the OBMC process applied to a current block.

FIG. 12 illustrates an embodiment of padding for generating padded samples by extrapolation original reference samples.

FIG. 13 is a flowchart shows an exemplary embodiment of processing a current block with an adaptive number of OBMC blending lines.

FIG. 14 is a flowchart shows an exemplary embodiment of processing a current block with OBMC by extending reference samples for generating OBMC regions.

FIG. 15 illustrates an exemplary system block diagram for a video encoding system incorporating the video processing method according to embodiments of the present invention.

FIG. 16 illustrates an exemplary system block diagram for a video decoding system incorporating the video processing method according to embodiments of the present invention.

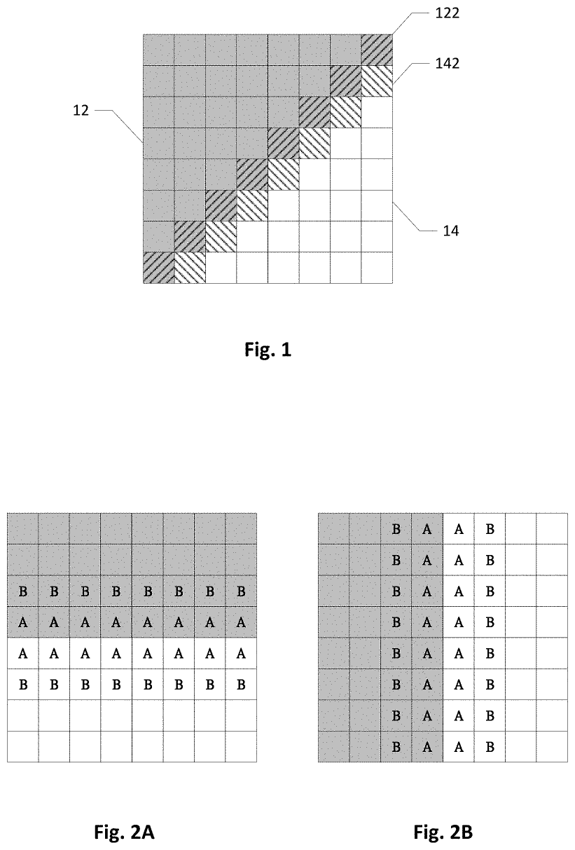

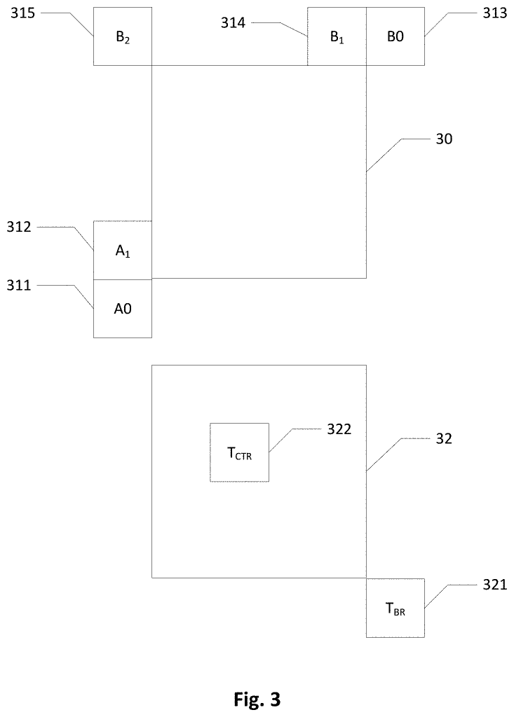

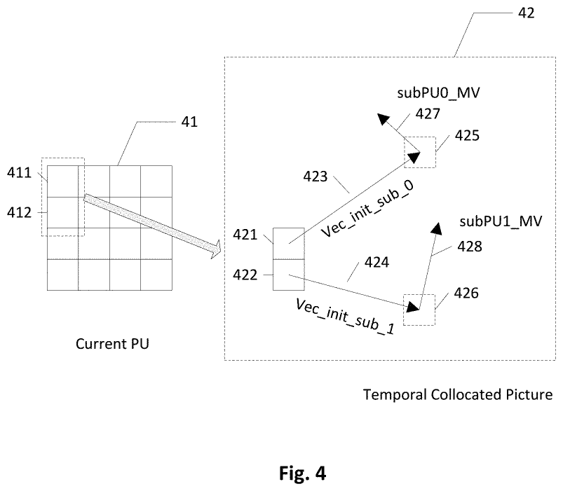

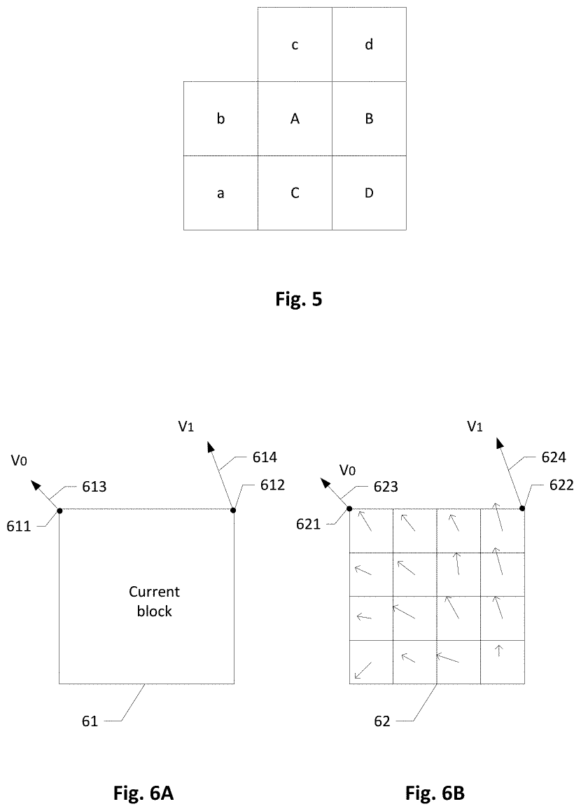

### DETAILED DESCRIPTION OF THE INVENTION

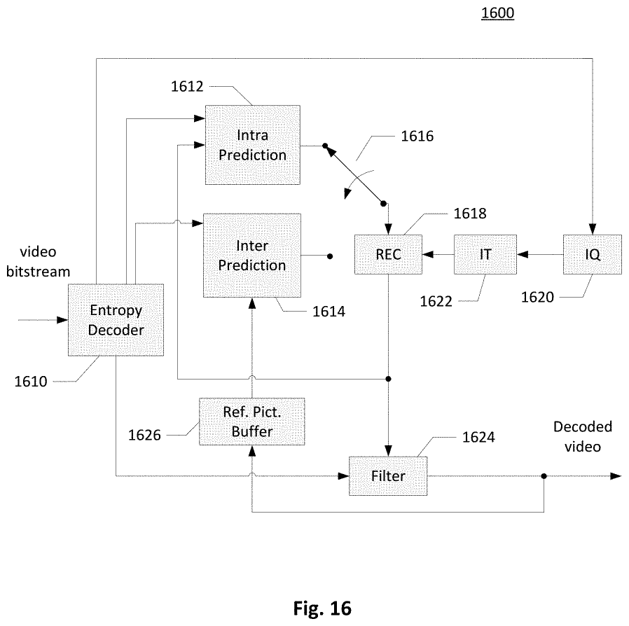

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. In this disclosure, systems and methods are described for reducing the memory bandwidth required for applying Overlapped Block Motion Compensation (OBMC) in one or both implementation schemes, and each or a combination of the embodiments may be implemented in a video encoder or video decoder. An exemplary video encoder and decoder implementing one or a combination of the embodiments are illustrated in FIGS. 15 and 16 respectively. Various embodiments in the disclosure also reduce the computation complexity. Systems and methods described herein are organized in sections as follows. The section “Adaptive Number of OBMC Blending Lines” demonstrates exemplary methods of adaptively determining a number of OBMC blending lines for OBMC. The required memory bandwidth and line buffers may be reduced by reducing the number of OBMC blending line in certain conditions. The section “OBMC with Padding” describes exemplary methods of extending reference samples by a padding method for generating one or more OBMC regions for the OBMC process. The section “OBMC Prediction Direction Constraints” describes exemplary methods of employing OBMC only with uni-prediction according to a predefined criterion. The section “Representative Flowcharts of Exemplary Embodiments” describes exemplary methods of processing a current block with OBMC utilizing two representative flowcharts. The section “Video Encoder and Decoder Implementation” together with FIGS. 15 and 16 illustrate a video encoding system and a video decoding system incorporating one or a combination of the described video processing methods.

In various embodiments of the present invention described in the following, it is assumed that an 8-tap interpolation filter is employed for performing motion compensation. It is also assumed there is only one neighboring block at each side of a current block for simplicity. The current block and neighboring block in the following descriptions may be a Coding Block (CB), Prediction Block (PB) or sub-block.

Adaptive Number of OBMC Blending Lines

In order to reduce the required bandwidth for the OBMC process, some embodiments of the present invention adaptively determine the number of OBMC blending lines. The number of OBMC blending lines is the number of pixels in the horizontal direction in a left or right OBMC region or the number of pixels in the vertical direction in a top or bottom OBMC region. The number of OBMC blending lines is also defined as the number of rows of pixels on the horizontal boundary or the number of columns of pixels on the vertical boundary processed by OBMC blending. Since the worst case memory bandwidth of motion compensation happens when a video encoder or decoder processes a small block predicted with bi-direction prediction, some exemplary embodiments reduce a number of OBMC blending lines according to a block size, motion information, or both the block size and motion information. For example, the number of OBMC blending lines is reduced if a block size is less than or equal to a block size threshold or a block area threshold, some examples of the block size threshold are 8×8 and 4×4, and some examples of the block area threshold are 64 and 16. In one embodiment, the default number of OBMC blending lines is 4 for the luminance (luma) component and 2 for chrominance (chroma) components. The number of OBMC blending lines for the luma component is reduced to 2 if the block size is less than or equal to the block size threshold or block area threshold. The number of OBMC blending lines for the chroma components may be reduced to 1 according to the number of OBMC blending lines for the luma component or according to a comparison result of chroma block size comparison. Some examples of the motion information include one or a combination of a Motion Vector (MV), inter direction, reference picture list, reference picture index, and picture order count of the reference picture. In one embodiment, the number of OBMC blending lines is determined according to the inter direction of the current block or neighboring block, so different OBMC blending lines are used for uni-predicted OBMC and bi-predicted OBMC. For example, more OBMC blending lines are employed for uni-predicted OBMC comparing to the OBMC blending lines for bi-predicted OBMC. In an example of the pre-generation implementation scheme, each of the OBMC regions generated by a MV of a uni-predicted block is larger than each of the OBMC regions generated by MVs of a bi-predicted block. In an example of the on-the-fly implementation scheme, the OBMC region generated by a MV of a uni-predicted neighboring block is larger than the OBMC region generated by MVs of a bi-predicted neighboring block. In another embodiment, the number of OBMC blending lines is determined according to both the inter directions of the current block and the neighboring block. For example, the number of OBMC blending lines is reduced if any of the current block and neighboring block is bi-predicted. In another example, the number of OBMC blending lines is reduced only if both the current block and neighboring block are bi-predicted. A specific example of the number of OBMC blending lines is 4 for uni-predicted OBMC and 2 for bi-predicted OBMC.

The adaptive number of OBMC blending lines methods may be applied to only one direction or one side, for example, the number of OBMC blending lines in the above and/or bottom OBMC region is adaptively reduced according to one or more conditions while the number of OBMC blending lines in the left or right OBMC regions is fixed. Alternatively, the number of OBMC blending lines in the left and/or right OBMC region may be adaptively reduced according to one or more conditions while the number of OBMC blending lines in the above or bottom OBMC region is fixed.

The pre-generation implementation scheme of OBMC reduces the memory bandwidth by fetching OBMC regions, for example, an OBMC region for a bottom neighboring block and an OBMC region for a right neighboring block, together with an original predictor of a current block when performing motion compensation on the current block. The predictors of the OBMC regions are stored in a buffer for the OBMC process of neighboring blocks. In the case when a current block is a bottom block in a Coding Tree Unit (CTU), the OBMC predictor of the OBMC region for a bottom neighboring block is stored in a line buffer until the video encoder or decoder processes the bottom neighboring block. The size of the line buffer has to be greater than or equal to a picture width times the number of OBMC blending lines because the bottom neighboring block is located in a next CTU row, and the motion compensation process is performed in a raster scan order from left to right and top to bottom in units of CTUs, the video encoder or decoder will not perform motion compensation on this bottom neighboring block until all blocks in the current CTU row are processed by motion compensation. The line buffer thus stores all the OBMC predictors of the bottom OBMC regions derived by motion information of all bottom blocks of the current CTU row. In order to reduce the memory required, embodiments of the present invention reduce the OBMC blending lines for a boundary of a current block according to a location of the current block. For example, the number of OBMC blending lines in an OBMC region derived from a neighboring block is reduced when the neighboring block and the current block are not in a same region. Some examples of the region are CTU, CTU row, tile, or slice. In some embodiments, when a video encoder or decoder performs motion compensation on a current block which is a bottom block of a CTU, the height of the bottom OBMC region is reduced from 4 to 0, 1, or 2. In one specific embodiment, when the above neighboring block is in a different CTU row, the number of OBMC blending lines at the top boundary of the current block is reduced to 0. In other words, the OBMC process is disabled at CTU row boundaries. In another embodiment, the number of OBMC blending lines at the top boundary of the current block located right below a CTU boundary is reduced to 1 or 2, that is, the height of an above OBMC region is 1 or 2 pixels.

In another embodiment of adaptively determining the number of OBMC blending lines, the number of OBMC blending lines for sub-block OBMC is reduced according to a coding mode of the current block. For example, the number of OBMC blending lines for sub-block OBMC is reduced to one when the current block is an affine coded block. For each sub-block, only one line of motion compensation results is generated using the MV of each neighboring block/sub-block. The one line of motion compensation results is then blended with one line of current motion compensation results generated using the MV of the current sub-block. In another example, a video decoder fetches a reference block with a size (M+2)×(N+2) for performing motion compensation for each M×N sub-block. The additional one line in each direction of motion compensation results is stored and used for the OBMC process of a neighboring sub-block. In this embodiment, one OBMC blending line is employed in sub-block OBMC if the block is coded in affine mode, while one or more lines of OBMC blending lines are employed if the block is not coded in affine mode, for example, the block is coded in one of other sub-block modes such as ATMVP. In some other embodiments, the number of OBMC blending lines of an affine coded sub-block can be different in different situations. For example, the number of OBMC blending lines may be determined by further considering one or both of the sub-block size and the inter prediction direction. More OBMC blending lines may be employed in the OBMC process of a large sub-block or a uni-predicted sub-block compared to the OMBC blending lines for a small sub-block or a bi-predicted sub-block.

OBMC with Padding

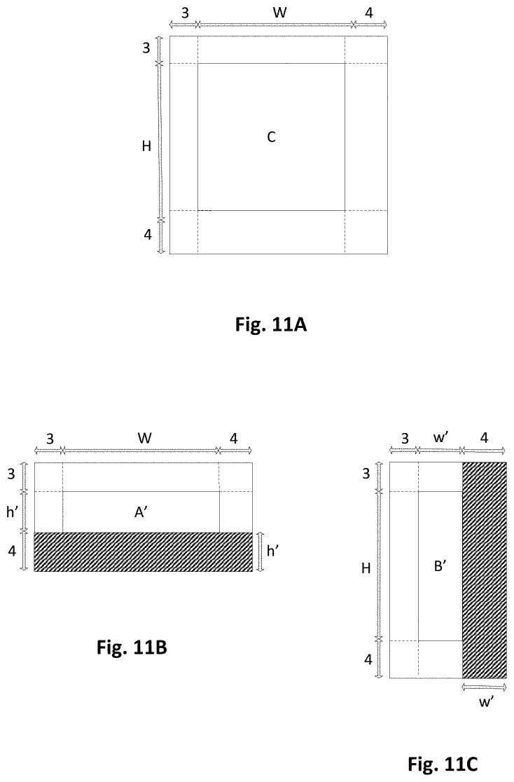

In order to reduce the additional memory bandwidth required by the OBMC process, a padding method is applied to extend reference samples when the video encoder or decoder is performing motion compensation and OBMC on a current block. The current block may be a Coding Block (CB) or a sub-block. In the following embodiments, an 8-Tap interpolation filter is used in the motion compensation process. The padding method is applied to generate pseudo reference samples outside an available reference region by using the pixels inside the available reference region. FIG. 10A an embodiment of extending an available reference region by padding right-most w′ columns and bottom h′ rows, where w′ and h′ are the additional width and height required by the OBMC process. In the embodiment shown in FIG. 10A, (3+W+4)×(3+H+4) samples in the available reference region are the original reference samples required for performing motion compensation for a current block with a size W×H. In some other embodiments, the available reference region may contain more or less samples than the reference samples required by the motion compensation process of the current block. The embodiment shown in FIG. 10A is an OBMC pre-generation implementation scheme, where OBMC regions R and B are pre-generated when generating an original predictor C of the current block. The number of reference samples required for generating the original predictor C of the current block and the two OBMC regions is (3+W+4+w′)×(3+H+4+h′). Samples in the two shaded areas illustrate additional samples required by motion compensation for generating the OBMC regions R and B. The OBMC region R is pre-generated for a right neighboring block of the current block, and the OBMC region B is pre-generated for a bottom neighboring block of the current block. The width of the OBMC region R is w′, representing the OBMC process of the right neighboring block blends the OBMC region R with an original predictor of the right neighboring block by w′ OBMC blending lines. The height of the OBMC region B is h′, representing the OBMC process of the bottom neighboring block blends the OBMC region B with an original predictor of the bottom neighboring block by h′ OBMC blending lines. In order to reduce or eliminate the additional memory bandwidth introduced by the OBMC process, exemplary embodiments of the present invention utilizes a padding method to extend an available reference region to a larger region sufficient for generating one or more OBMC regions. In this embodiment shown in FIG. 10A, the additional memory bandwidth introduced for pre-generating the OBMC regions is eliminated by only fetching (3+W+4)×(3+H+4) original reference samples and extending the original reference samples to (3+W+w′+4)×(3+H+h′+4) samples by a padding method. The extended reference samples are therefore big enough for generating the original predictor C of the current block as well as the OBMC region R and OBMC region B. The two shaded areas shown in FIG. 10A represent the padded samples generated by one of various padding methods, and some exemplary padding methods will be described in later paragraphs.

For sub-block OBMC, four OBMC regions A, R, B, and L are pre-generated when generating an original predictor C of the current block as shown in FIG. 10B. FIG. 10B illustrates applying padding to the left-most w′ columns, right-most w′ columns, top h′ rows, and bottom h′ rows of an available reference region fetched for a W×H current block, where w′ and h′ are the number of OBMC blending lines for performing OBMC at vertical and horizontal boundaries. The current block in this example is a sub-block. Similar to FIG. 10A, (3+W+4)×(3+H+4) samples in the available reference region are the original reference samples fetched for performing motion compensation for the current block assuming a 8-Tap interpolation filter is used in the motion compensation process. The pre-generation implementation scheme of sub-block OBMC pre-generates OBMC regions A, R, B, and L for each of the four neighboring blocks/sub-blocks, thus the number of reference samples required for generating the original predictor C of the current block and the four OBMC regions will increase from (3+W+4)×(3+H+4) to (w′+3+W+4+w′)×(h′+3+H+4+h′). Samples in the four shaded areas are additional samples required by motion compensation for generation the four OBMC regions. Embodiments of sub-block OBMC with padding utilizes a padding method to extend the available reference region with (3+W+4)×(3+H+4) original reference samples to a larger area with (w′+3+W+4+w′)×(h′+3+H+4+h′) samples. The four shaded areas in FIG. 10B are generated by one of various padding methods to avoid fetching additional reference samples for sub-block OBMC. In some other embodiments, more or less original reference samples may be fetched from the memory, and the padding method is applied to extend the original reference samples to have sufficient samples for generating one or more OBMC regions.

FIGS. 11A, 11B, and 11C illustrate an example of extending original reference samples for an on-the-fly implementation scheme of the OBMC process applied to a current block with a size W×H. In FIG. 11A, an area of (3+W+4)×(3+H+4) original reference samples is fetched using motion information of the current block for generating an original predictor C of the current block. In FIG. 11B, an area of (3+W+4)×(3+h′+4) reference samples is required for motion compensation of an OBMC region A′, and in FIG. 11C, an area of (3+w′+4)×(3+H+4) reference samples is required for motion compensation of an OBMC region B′. Here w′ and h′ represent the width of the OBMC region B′ and the height of the OBMC region A′ respectively, where w′ and h′ equal to 4 pixels in the embodiment shown in FIGS. 11B and 11C. Some exemplary embodiments of the present invention apply a padding method to the on-the-fly implementation scheme to reduce the additional bandwidth requirement for OBMC. For example, the bottom h′ rows of the area (3+W+4)×(3+h′+4) in FIG. 11B and the right-most w′ columns of the area (3+w′+4)×(3+H+4) in FIG. 11C are generated by padding. The number of original reference samples fetched from the memory using motion information of an above neighboring block of the current block is reduced from (3+W+4)×(3+h′+4) samples to (3+W+4)×(3+4) samples, and the number of original reference samples fetched from the memory using motion information of a left neighboring block of the current block is reduced from (3+w′+4)×(3+H+4) to (3+4)×(3+H+4).

Some examples of the padding method used to extend the original reference samples for generating one or more OBMC regions are replicating (e.g. copy or extension of boundary reference samples), mirroring, and extrapolating. FIGS. 10A and 10 B are referred by the following examples, where the shaded areas in FIGS. 10A and 10B are padded samples generated from original reference samples. Padding by replicating repeats the boundary samples of the original fetched reference samples. For example, the right-most w′ columns and the bottom h′ rows as shown in the shaded areas of FIG. 10A are generated by replicating the right-most column and the bottom row of the original fetched reference samples for motion compensation of the current block. Similarly, the right-most w′ columns, the left-most w′ columns, the top h′ rows, and the bottom h′ rows as shown in the shaded areas of FIG. 10B are generated by replicating the right-most column, the left-most column, the top row, and the bottom row of the original fetched samples respectively. In one embodiment of padding by replicating boundary samples, the boundary samples are copied to a buffer for storing padded samples. In another embodiment of padding by replicating boundary samples, the filter design is modified to access the boundary samples instead of the padded samples when padded samples are required for interpolation during motion compensation. Modifying the filter design removes the copying process and the additional temporary buffers required to store the padded samples.

The following examples assume the number of OBMC blending lines is two for both horizontal and vertical directions. An example of padding by mirroring the original reference samples along the boundary generates a first column in the shaded area located at the right of the original reference samples as shown in FIG. 10A by copying the right-most column of the original reference samples (i.e. column (3+W+4−1)). A second column in the shaded area is generated by copying the column (3+W+4−2). Similarly, a first row in the shaded area located at the bottom of the original reference samples is generated by copying the bottom-most row of the original reference samples (i.e. row (3+H+4−1)), and a second row in the shaded area is generated by copying the row (3+H+4−2). For sub-block OBMC, a first column in the right shaded area as shown in FIG. 10B is a copy of the right-most column of the original reference samples (i.e. column (3+W+4−1)), and a second column in the right shaded area is a copy of the column (3+W+4-2). A first column in the left shaded area as shown in FIG. 10B is a copy of the second column of the original reference samples, and a second column in the left shaded area is a copy of the first column of the original reference samples. A first row in the bottom shaded area is a copy of the bottom-most row of the original reference samples (i.e. row (3+H+4−1)), and a second row in the bottom shaded area is a copy of the row (3+H+4−2). A first row in the above shaded area is a copy of a second row of the original reference samples and a second row in the above shaded area is a copy of a first row of the original reference samples. An embodiment of padding by mirroring modifies the filter design to remove copying process and the additional temporary buffers required to store the padded samples. For example, samples in the right-most column of the original reference samples are accessed instead of padded samples if samples in the first padded column are required for interpolation during motion compensation.

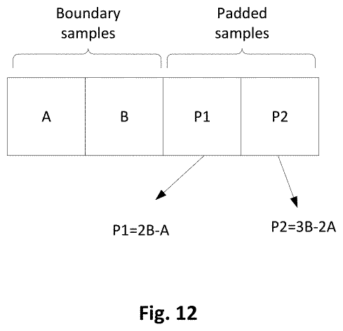

In some other embodiments, padding is achieved by extrapolating the original reference samples near the boundaries. The extrapolation can be done by any extrapolation method. For example, a simple gradient-based extrapolation method is shown in FIG. 12, where A and B are boundary samples of the original reference samples, and P1 and P2 are padded samples generated by the gradient-based extrapolation method. The extrapolation padding can be done by first generating padded samples, and then storing into a temporary buffer for motion compensation. Alternatively, the extrapolation padding may be realized by modifying the filter design. For example, if samples in the first padded column are required for interpolation during motion compensation, samples in the right-most column and the second right-most column of the original reference samples are accessed to compute the padded samples directly.

In one embodiment, interpolation filter coefficients are modified to avoid accessing any pixel outside of an available reference region. An example of the available reference region contains (M+t−1)×(N+t−1) reference samples fetched for motion compensation of a current block with a size M×N using a t-tap interpolation filter. For example, the filter coefficients that applied on the pixels outside of the available reference region are all set to zero, and the filter weights or coefficients are added to the coefficients that applied on the pixels inside the available reference region. In an example of modifying the interpolation filter coefficients, the filter weight originally applied on a pixel outside of the available reference region is added to a center pixel of the interpolation filter. In another example of modifying the interpolation filter coefficients, the filter weight is added to a boundary pixel of the available reference region.

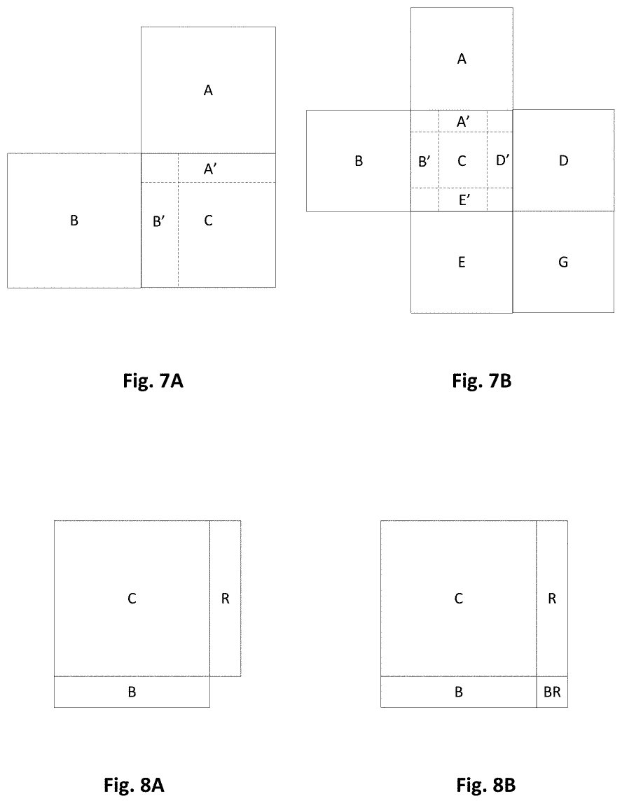

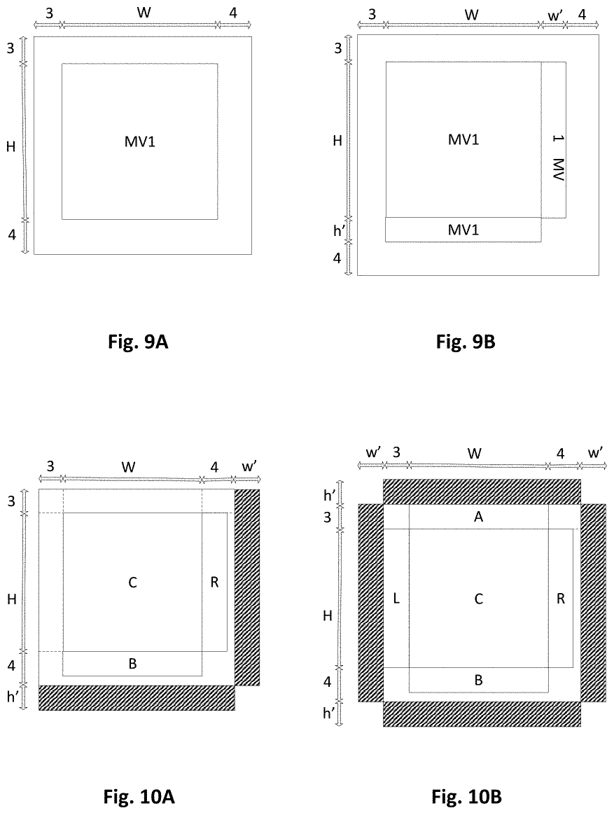

The padding method may be implemented by copying original reference samples which are already used for non-OBMC motion compensation to a temporary buffer, then filling the bottom rows and right-most columns with padded samples. For example, an area of (3+W_luma+4)×(3+H_luma+4) original reference samples are copied to a temporary buffer, and the bottom h_luma′ rows in the temporary buffer are copies of row (3+H_luma+4−1) when performing motion compensation for generating luma OBMC block A, where luma OBMC_block_A is an OBMC region generated by an above neighboring MV(s), which is the OBMC region A′ in FIG. 7A. The right w luma′ columns in the temporary buffer are copies of column (3+W_luma+4−1) when performing motion compensation for generating luma OBMC_block_L, where luma_OBMC_block__L is an OBMC region generated by a left neighboring MV(s), which is the OBMC region B′ in FIG. 7A. Similar implementation may be applied for the chroma components. Original reference samples with a size (1+W_chroma+2)×(1+H_chroma+2) are copied to a temporary buffer, and bottom h chroma′ rows in the temporary buffer are copies of row (1+H chroma+2−1) when performing motion compensation for generating chroma_OBMC_block_A, where chroma_OBMC_block_A is an OBMC region generated by an above neighboring MV(s). Right w_chroma′ columns in the temporary buffer are copies of column (1+W_chroma+2−1) when performing motion compensation for generating chroma_OBMC_block_L, where chroma_OBMC_block_L is an OBMC region generated by a left neighboring MV(s).

In another implementation embodiment of padding, the filter design is changed to access a different address in the buffer when padded samples are required. For example, when samples in row (3+H luma+4) to row (3+H_luma+4+h_luma′−1) are required to perform interpolation filtering for luma_OBMC_block A, samples in row (3+H_luma+4−1) will be accessed as the padded samples. Since data in row (3+H_luma+4) to row (3+H_luma+4+h_luma′−1) will never be fetched in this implementation embodiment, the buffer only needs to store the original reference samples (3+W_luma+4)×(3+H_luma+4). Similarly, when samples in column (3+W_luma+4) to column (3+W_luma+4+w_luma′−1) are required to perform interpolation filtering for luma OBMC_block_L, samples in column (3+W_luma+4−1) will be accessed as the padded samples. There is no need to fetch the data in column (3+W luma+4) to column (3+W_luma+4+w_luma′−1). When performing interpolation filtering for chroma_OBMC_block_A, samples in row (1+H chroma+2−1) will be accessed as the padded samples if data in row (1+H_chroma+2) to row (1+H_chroma+2+h_chroma′−1) are required; and when performing interpolation filtering for chroma_OBMC_block_L, samples in column (1+W_chroma+2−1) will be accessed as the padded samples when data in column (1+W_chroma+2) to column (1+W_luma+2+w_chroma′−1) are required.

For sub-block OMBC, two more operations for OBMC_block_B and OBMC_block_R are required, where OBMC_block_B and OBMC_block_R corresponds to OBMC region E′ and OBMC region D′ in FIG. 7B respectively. OBMC predictors for OBMC_block_B and OBMC_block_R are generated using a bottom neighboring MV(s) and a right neighboring MV(s). In one embodiment of padding implementation, the original reference samples with a size (3+W_luma+4)×(3+H_luma+4) are copied to a temporary buffer. The top h luma′ rows in the temporary buffer are copies of row (h_luma′) if the motion compensation is performed for generating luma_OBMC_block B, and the left w_luma′ columns in the temporary buffer are copies of column (w_luma′) if the motion compensation is performed for generating luma_OBMC_block_R. The original reference samples with a size (1+W_chroma+2)×(1+H_chroma+2) are copied to a temporary buffer. The top h_chroma′ row in the temporary buffer are copies of row (h_chroma′) if the motion compensation is performed to generate chroma_OBMC_block_B, and the left w_chroma′ column in the temporary buffer are copies of column (w_chroma′) if the motion compensation is performed to generate chroma_OBMC_block_L.

In another embodiment of padding implementation for sub-block OBMC, the padding operation is performed by changing the filter design to access a different address in the buffer. For example, samples in row (h_luma′) will be accessed as the padded samples if data in row (0) to row (h_luma′−1) are required when performing interpolation filtering for generating luma_OBMC_block_B. The buffer size may be reduced as fetching of data in row (0) to row (h_luma′−1) is no longer required. Samples in column (w_luma′) will be accessed as the padded samples if data in column (0) to column (w_luma′−1) are required when performing interpolation filtering for generating luma_OBMC_block_R. Similarly, samples in row (h_chroma′) will be accessed as the padded samples if data in row (0) to row (h_chroma′−1) are required during interpolation filtering for chroma_OBMC_block B, and samples in column (w_chroma′) will be accessed as the padded samples if data in column (0) to column (w_chroma′−1) are required during interpolation filtering for chroma_OBMC_block_R.

The padding method for extending the reference samples for OBMC or sub-block OBMC may be applied to both luma and chroma components, or the padding method may be applied only to the luma component or chroma components.

Some embodiments of utilizing a padding method to extend the reference samples are adaptively enabled. In one embodiment, padding for extending the reference samples is only applied to CU boundary OBMC, for example, during motion compensation of a current CU, the right-most w′ columns and the bottom h′ row of the reference samples are extended by a padding method for generating OBMC regions B and OBMC region R as shown in FIG. 10A. In this embodiment, sub-block OBMC uses only real reference samples for generating OBMC regions. In another embodiment, padding for extending the reference samples is applied only in sub-block OBMC, and is not applied in block level OBMC. In yet another embodiment, padding for extending the reference samples is applied to sub-block OBMC and all OBMC process at CTU row boundaries, so only real reference samples are used to generate OBMC regions for the OBMC process at block level boundaries other than the CTU row boundaries.

In some embodiments of padding for OBMC or sub-block OBMC, the padding method is only applied to the vertical direction, for example, OBMC region A and OBMC region B in FIG. 10B are generated by both the original reference samples and padded samples while OBMC region L and OBMC region R are generated by only the original reference samples. Alternatively, the padding method in some other embodiments only apply padding to the horizontal direction, for example, OBMC region L and OBMC region R are generated by both the original reference samples and padded samples while OBMC region A and OBMC region B are generated by the original reference samples.

OBMC Prediction Direction Constraints

Some embodiments of restricted OBMC only allow uni-prediction for OBMC region generation as bi-prediction is not permitted for generating OBMC regions. An embodiment of the restricted OBMC adaptively disables OBMC or use uni-prediction according to a current block size, a neighboring block size, or both the current and neighboring block sizes. For example, uni-prediction is used to generate OBMC region A and/or OBMC region L as shown in FIG. 10B, and if the block size of a current block or current sub-block is smaller than a threshold, OBMC is disabled for the current block or current sub-block. In another example, the restricted OBMC only allows using uni-prediction to generate OBMC region A, and if the block size of an above neighboring block is smaller than a threshold, OBMC region A is not generated as OBMC is not performed at the boundary between the current block and the above neighboring block. Similarly, the restricted OBMC only allows using uni-prediction to generate OBMC region L, and if the block size of a left neighboring block is smaller than a threshold, OBMC region L is not generated as OBMC is not performed at the boundary between the current block and the left neighboring block. In another embodiment, uni-prediction is used to generate OBMC region B and/or OBMC region R in FIG. 10B, and if the block size of the current block or current sub-block is smaller than a threshold, OBMC region B and/or OBMC region R are not generated. Some other embodiments allow bi-prediction for OBMC region generation only if a current block size, a neighboring block size, or one of the current and neighboring block sizes is greater than a threshold, otherwise, OBMC regions are generated using uni-prediction.

The block size threshold may be 8×8 or 4×4 block, or the block area threshold may be 64 or 16. In a case when the current block or the neighboring blocks are divided into several sub-blocks, the video encoder or decoder performs motion information check on each neighboring sub-block, and if the motion information are the same, motion compensation of multiple sub-block can be performed at the same time, which means the sub-blocks can be merged and the block size of the merged block is increased. For example, the above neighboring block is divided to several 4×4 sub-blocks and the 4×4 sub-blocks are smaller than the block area threshold of 64, if the motion information of the four 4×4 neighboring blocks are the same, it can be treated as a 16×4 block, whose area is not smaller than the block area threshold, in this case the original OBMC can be applied.

Representative Flowcharts of Exemplary Embodiments

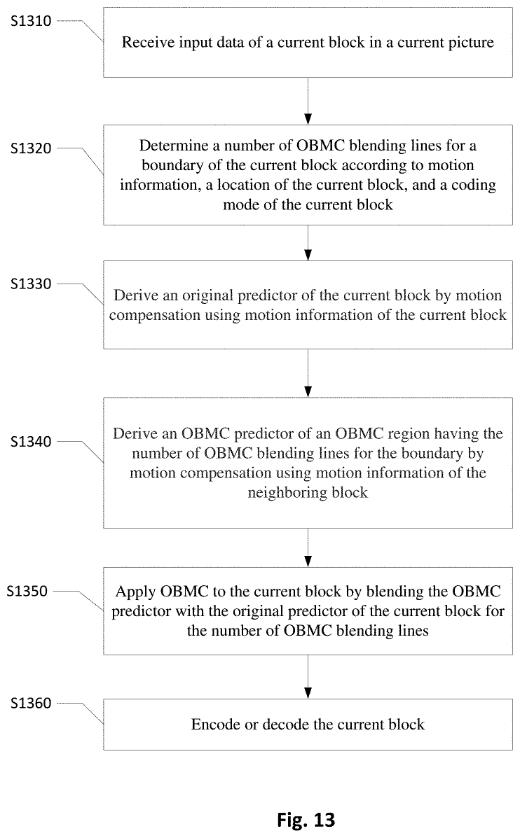

FIG. 13 illustrates an exemplary flowchart for a video encoding or decoding system processing video data with OBMC according to some embodiments of the present invention. The video encoding or decoding system receives input video data associated with a current block in a current picture in Step S1310. The current block is a current CB, a current PB, or a current sub-block. At the encoder side, the input video data corresponds to pixel data to be encoded. At the decoder side, the input data corresponds to coded data or prediction residual to be decoded. In Step S1320, the video encoding or decoding system determines a number of OBMC blending lines for a boundary of the current block according to motion information, a location of the current block, a coding mode of the current block, or a combination thereof. For example, the number or OBMC blending lines is reduced if the current block is a bi-predicted block, an affine coded block, or if the current block and the neighboring block are not in a same region. The boundary is between the current block and a neighboring block, and the neighboring block is a neighboring CB, a neighboring PB, or a neighboring sub-block. An original predictor of the current block is derived in Step S1330 by motion compensation using MV(s) of the current block. In Step S1340, an OBMC predictor of an OBMC region having the number of OBMC blending lines is derived by motion compensation using MV(s) of the neighboring block. The video encoding or decoding system applies OBMC to the current block in Step S1350 by blending the OBMC predictor with the original predictor of the current block for the number of OBMC blending lines. The current block is then encoded or decoded in Step S1360.

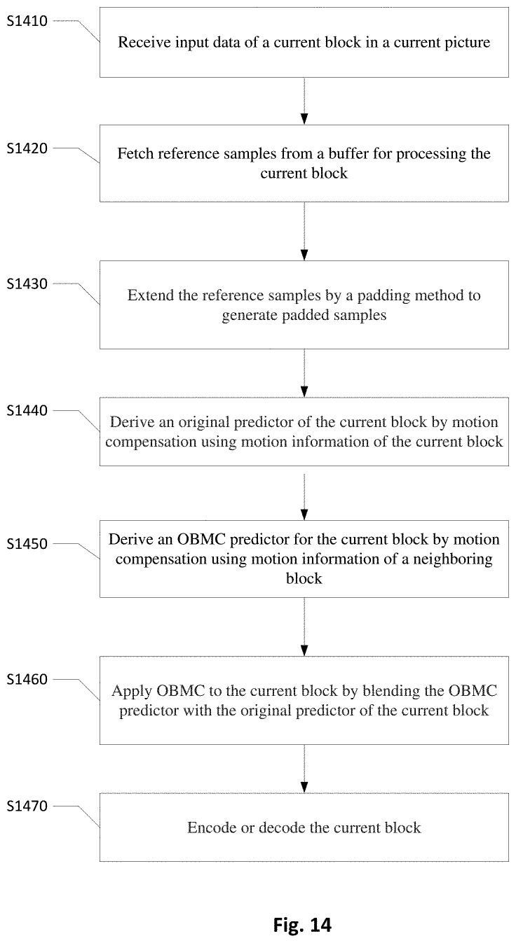

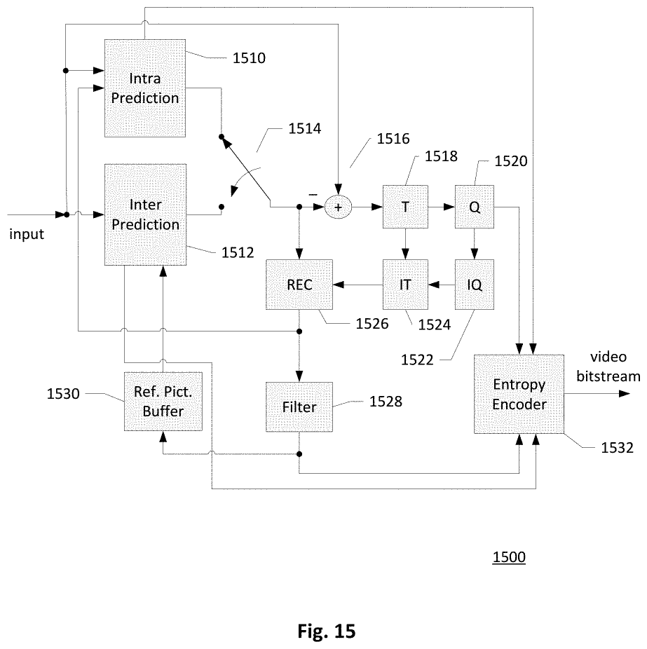

FIG. 14 illustrates an exemplary flowchart for a video encoding or decoding system processing video data with OBMC according to some other embodiments of the present invention. The video encoding or decoding system receives input video data associated with a current block in a current picture in Step S1410. The current block is a current CB, a current PB, or a current sub-block. At the encoder side, the input video data corresponds to pixel data to be encoded. At the decoder side, the input data corresponds to coded data or prediction residual to be decoded. In Step S1420, reference samples are fetched from a buffer for processing the current block, and in Step S1430, the reference samples are extended by a padding method for generating one or more OBMC regions. The video encoding or decoding system derives an original predictor of the current block by motion compensation using MV(s) of the current block in Step S1440, and derives an OBMC predictor for the current block by motion compensation using MV(s) of a neighboring block in Step S1450. In Step S1460, the video encoding or decoding applies OBMC to the current block by blending the OBMC predictor with the original predictor of the current block, and the current block is encoded or decoded in Step S1470. For the OBMC pre-generation implementation scheme, the extended reference samples are used to generate one or more OBMC regions for the OBMC process of one or more neighboring block. For the OBMC on-the-fly implementation scheme, the extended reference samples are used to generate one or more OBMC regions in Step S1450, and the OBMC predictor in the OBMC region is blended with the original predictor of the current block in Step S1460.

Video Encoder and Decoder Implementations

The foregoing proposed video processing methods can be implemented in video encoders or decoders. For example, a proposed video processing method is implemented in a predictor derivation module of an encoder, and/or predictor derivation module of a decoder. In another example, a proposed video processing method is implemented in a motion compensation module of an encoder, and/or a motion compensation module of a decoder. Alternatively, any of the proposed methods is implemented as a circuit coupled to the predictor derivation or motion compensation module of the encoder and/or the predictor derivation module or motion compensation module of the decoder, so as to provide the information needed by the predictor derivation module or the motion compensation module.

FIG. 15 illustrates an exemplary system block diagram for a Video Encoder 1500 implementing various embodiments of the present invention. Intra Prediction 1510 provides intra predictors based on reconstructed video data of a current picture. Inter Prediction 1512 performs motion estimation (ME) and motion compensation (MC) to provide inter predictors based on video data from other picture or pictures. To encode a current block with OBMC according to some embodiments of the present invention, a number of OBMC blending lines is adaptively determined according to motion information, a location of the current block, or a coding mode of the current block. An OBMC region for the current block is generated with the number of OBMC blending lines. For example, the number of OBMC blending lines for a bottom boundary is reduced to zero if the current block is located just above a CTU row, or the number of OBMC blending lines for an above boundary is reduced to zero if the current block is located just below a CTU row. In some other embodiments, the Inter Prediction 1512 performs motion compensation using an extended reference samples to generate one or more OBMC regions for the OBMC process. The extended reference samples are generated by padding from original reference samples fetched from a buffer. The Inter Prediction 1512 derives an original predictor of the current block. OBMC is applied to the current block by blending one or more OBMC predictors with the original predictor in the Inter Prediction 1512. Either Intra Prediction 1510 or Inter Prediction 1512 supplies the selected predictor to Adder 1516 to form prediction errors, also called prediction residual. The prediction residual of the current block are further processed by Transformation (T) 1518 followed by Quantization (Q) 1520. The transformed and quantized residual signal is then encoded by Entropy Encoder 1532 to form a video bitstream. The video bitstream is then packed with side information. The transformed and quantized residual signal of the current block is processed by Inverse Quantization (IQ) 1522 and Inverse Transformation (IT) 1524 to recover the prediction residual. As shown in FIG. 15, the prediction residual is recovered by adding back to the selected predictor at Reconstruction (REC) 1526 to produce reconstructed video data. The reconstructed video data may be stored in Reference Picture Buffer (Ref. Pict. Buffer) 1530 and used for prediction of other pictures. The reconstructed video data recovered from REC 1526 may be subject to various impairments due to encoding processing; consequently, In-loop Processing Filter 1528 is applied to the reconstructed video data before storing in the Reference Picture Buffer 1530 to further enhance picture quality.

A corresponding Video Decoder 1600 for decoding the video bitstream generated from the Video Encoder 1500 of FIG. 15 is shown in FIG. 16. The video bitstream is the input to Video Decoder 1600 and is decoded by Entropy Decoder 1610 to parse and recover the transformed and quantized residual signal and other system information. The decoding process of Decoder 1600 is similar to the reconstruction loop at Encoder 1500, except Decoder 1600 only requires motion compensation prediction in Inter Prediction 1614. Each block is decoded by either Intra Prediction 1612 or Inter Prediction 1614. Switch 1616 selects an intra predictor from Intra Prediction 1612 or an inter predictor from Inter Prediction 1614 according to decoded mode information. Inter Prediction 1614 performs OBMC on a current block by blending an original predictor and OBMC predictor with an adaptive number of OBMC blending lines according to some exemplary embodiments. In some other embodiments, Inter Prediction 1614 generates one or more OBMC regions using extended reference samples. The extended reference samples are generated by a padding method applied to original reference samples fetched from a buffer. The transformed and quantized residual signal associated with each block is recovered by Inverse Quantization (IQ) 1620 and Inverse Transformation (IT) 1622. The recovered residual signal is reconstructed by adding back the predictor in REC 1618 to produce reconstructed video. The reconstructed video is further processed by In-loop Processing Filter (Filter) 1624 to generate final decoded video. If the currently decoded picture is a reference picture for later pictures in decoding order, the reconstructed video of the currently decoded picture is also stored in Ref. Pict. Buffer 1626.

Various components of Video Encoder 1500 and Video Decoder 1600 in FIG. 15 and FIG. 16 may be implemented by hardware components, one or more processors configured to execute program instructions stored in a memory, or a combination of hardware and processor. For example, a processor executes program instructions to control receiving of input data associated with a current picture. The processor is equipped with a single or multiple processing cores. In some examples, the processor executes program instructions to perform functions in some components in Encoder 1500 and Decoder 1600, and the memory electrically coupled with the processor is used to store the program instructions, information corresponding to the reconstructed images of blocks, and/or intermediate data during the encoding or decoding process. The memory in some embodiments includes a non-transitory computer readable medium, such as a semiconductor or solid-state memory, a random access memory (RAM), a read-only memory (ROM), a hard disk, an optical disk, or other suitable storage medium. The memory may also be a combination of two or more of the non-transitory computer readable mediums listed above. As shown in FIGS. 15 and 16, Encoder 1500 and Decoder 1600 may be implemented in the same electronic device, so various functional components of Encoder 1500 and Decoder 1600 may be shared or reused if implemented in the same electronic device.

Embodiments of the video processing method for encoding or decoding may be implemented in a circuit integrated into a video compression chip or program codes integrated into video compression software to perform the processing described above. For examples, determining of a candidate set including an average candidate for coding a current block may be realized in program codes to be executed on a computer processor, a Digital Signal Processor (DSP), a microprocessor, or field programmable gate array (FPGA). These processors can be configured to perform particular tasks according to the invention, by executing machine-readable software codes or firmware codes that defines the particular methods embodied by the invention.

Reference throughout this specification to “an embodiment”, “some embodiments”, or similar language means that a particular feature, structure, or characteristic described in connection with the embodiments may be included in at least one embodiment of the present invention. Thus, appearances of the phrases “in an embodiment” or “in some embodiments” in various places throughout this specification are not necessarily all referring to the same embodiment, these embodiments can be implemented individually or in conjunction with one or more other embodiments. Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A video processing method for processing video data with Overlapped Block Motion Compensation (OBMC) in a video coding system, comprising:
receiving input video data associated with a current block in a current picture;
determining a number of OBMC blending lines for a boundary of the current block according to one or a combination of motion information, a location of the current block, and a coding mode of the current block, wherein the boundary is between the current block and a neighboring block;
deriving an original predictor of the current block by motion compensation using motion information of the current block;
deriving an OBMC predictor of an OBMC region having the number of OBMC blending lines for the boundary by motion compensation using motion information of the neighboring block;
applying OBMC to the current block by blending the OBMC predictor with the original predictor of the current block for the number of OBMC blending lines; and
encoding or decoding the current block.

2. The method of claim 1, further comprising comparing a block size of the current block with a block size threshold or a block area threshold, and reducing the number of OBMC blending lines if the block size is less than or equal to the block size threshold or the block area threshold.

3. The method of claim 1, wherein the motion information for determining the number of OBMC blending lines are motion information of the current block, the neighboring block, or both the current block and the neighboring block, and the motion information comprise one or a combination of a Motion Vector (MV), inter direction, reference picture list, reference picture index, and picture order count of a reference picture.

4. The method of claim 3, wherein the number of OBMC blending lines is reduced if the inter direction of the current block is bi-prediction, the inter direction of the neighboring block is bi-prediction, or both the inter directions of the current block and the neighboring block are bi-prediction.

5. The method of claim 1, wherein the number of OBMC blending lines for one or both of a top and a bottom boundary is adaptively determined according to one or a combination of motion information, a location of the current block, and a coding mode of the current block.

6. The method of claim 1, wherein the number of OBMC blending lines is determined by the location of the current block, and the number of OBMC blending lines is reduced if the current block and the neighboring block are not in a same region, wherein the region is a Coding Tree Unit (CTU), CTU row, tile, or slice in the current picture.

7. The method of claim 6, wherein the number of OBMC blending lines is reduced to 0 if the current block and the neighboring block are not in the same CTU row as OBMC is not applied to CTU row boundaries.

8. The method of claim 1, wherein the number of OBMC blending lines is determined according to the coding mode of the current block, and the number of OBMC blending lines for sub-block OBMC is reduced if the coding mode of the current block is affine motion compensation prediction.

9. An apparatus of processing blocks with Overlapped Block Motion Compensation (OBMC) in a video coding system, the apparatus comprising one or more electronic circuits configured for:
receiving input video data associated with a current block in a current picture;
determining a number of OBMC blending lines for a boundary of the current block according to one or a combination of motion information, a location of the current block, and a coding mode of the current block, wherein the boundary is between the current block and a neighboring block;
deriving an original predictor of the current block by motion compensation using motion information of the current block;
deriving an OBMC predictor of an OBMC region having the number of OBMC blending lines for the boundary by motion compensation using motion information of the neighboring block;
applying OBMC to the current block by blending the OBMC predictor with the original predictor of the current block for the number of OBMC blending lines; and
encoding or decoding the current block.

10. A non-transitory computer readable medium storing program instruction causing a processing circuit of an apparatus to perform a video processing method, and the method comprising:
receiving input video data associated with a current block in a current picture;
determining a number of OBMC blending lines for a boundary of the current block according to one or a combination of motion information, a location of the current block, and a coding mode of the current block, wherein the boundary is between the current block and a neighboring block;
deriving an original predictor of the current block by motion compensation using motion information of the current block;
deriving an OBMC predictor of an OBMC region having the number of OBMC blending lines for the boundary by motion compensation using motion information of the neighboring block;
applying OBMC to the current block by blending the OBMC predictor with the original predictor of the current block for the number of OBMC blending lines; and
encoding or decoding the current block.

11. A video processing method for processing blocks with Overlapped Block Motion Compensation (OBMC) in a video coding system, comprising:
receiving input video data associated with a current block in a current picture;
fetching reference samples from a buffer for processing the current block;
extending the reference samples by a padding method to generate padded samples, wherein the padded samples are used to generate one or more OBMC regions;
deriving an original predictor of the current block by motion compensation using motion information of the current block;
deriving an OBMC predictor for the current block by motion compensation using motion information of a neighboring block;
applying OBMC to the current block by blending the OBMC predictor with the original predictor of the current block; and
encoding or decoding the current block.

12. The method of claim 11, wherein the reference samples are fetched according to the motion information of the current block, and the method further comprising generating said one or more OBMC regions from the extended reference samples including the fetched reference samples and padded samples, and storing said one or more OBMC regions.

13. The method of claim 12, wherein said one or more OBMC regions comprise a right OBMC region and a bottom OBMC region, and the fetched reference samples are extended by padding w′ columns in the right of the fetched reference samples and h′ row in the bottom of the fetched reference samples, wherein w′ is a width of the right OBMC region and h′ is a height of the bottom OBMC region.

14. The method of claim 12, wherein said one or more OBMC regions comprise a right OBMC region, a left OBMC region, an above OBMC region, and a bottom OBMC region, and the fetched reference samples are extended by padding w′ columns in both left and right sides of the fetched reference samples and h′ rows in both above and bottom sides of the fetched reference samples, wherein w′ is a width of the left or right OBMC region and h′ is a height of the above or bottom OBMC region.

15. The method of claim 11, wherein the neighboring block is an above neighboring block or a left neighboring block, and said one or more OBMC regions is an above OBMC region or a left OBMC region, and the method further comprising fetching reference samples for generating the above OBMC region using the motion information of the above neighboring block or fetching reference samples for generating the left OBMC region using the motion information of the left neighboring block, generating the above OBMC region or left OBMC region from the fetched reference samples and padded samples, wherein the OBMC predictor of the above OBMC region or the left OBMC region is blended with the original predictor of the current block.

16. The method of claim 11, wherein the padding method includes replicating, mirroring, or extrapolating the reference samples to generate the padded samples.

17. The method of claim 16, further comprising copying reference samples having been used by non-OBMC motion compensation to a temporary buffer, and filling one or more boundaries of the reference samples by the padded samples generated by the padding method, wherein the size of the extended reference samples is sufficient for generating said one or more OBMC regions.

18. The method of claim 16, further comprising accessing the buffer to fetch one of the reference samples as a padded sample when the padded sample outside the reference samples is required for generating said one or more OBMC regions.

19. The method of claim 11, wherein the reference samples are extended by w′ columns and h′ rows, w′ is a number of OBMC blending lines for performing OBMC at a vertical boundary, and h′ is a number of OBMC blending lines for performing OBMC at a horizontal direction.

20. The method of claim 11, wherein the current block is a luminance (luma) block, and padding is not applied to extend reference samples used for generating one or more OBMC regions for corresponding chrominance (chroma) blocks, or the current block is a chroma block, and padding is not applied to extend reference samples used for generating one or more OBMC regions for a corresponding luma block.

21. The method of claim 11, wherein extending the reference samples by the padding method for generating said one or more OBMC regions is only applied to Coding Unit (CU) boundary OBMC, sub-block OBMC, or sub-block OBMC and Coding Tree Unit (CTU) row boundaries.

22. The method of claim 11, wherein extending the reference samples by the padding method for generating said one or more OBMC regions is only applied to a vertical direction blending or horizontal direction blending.

23. An apparatus of processing blocks with Overlapped Block Motion Compensation (OBMC) in a video coding system, the apparatus comprising one or more electronic circuits configured for:
receiving input video data associated with a current block in a current picture;
fetching reference samples for motion compensation of the current block;
extending the reference samples by a padding method to generate padded samples, wherein the padded samples are used to generate one or more OBMC regions;
deriving an original predictor of the current block from the fetched reference samples;
deriving an OBMC predictor for the current block by motion compensation using motion information of a neighboring block;
applying OBMC to the current block by blending the OBMC predictor with the original predictor of the current block; and
encoding or decoding the current block.

24. A non-transitory computer readable medium storing program instruction causing a processing circuit of an apparatus to perform a video processing method, and the method comprising:
receiving input video data associated with a current block in a current picture;
fetching reference samples for motion compensation of the current block;
extending the reference samples by a padding method to generate padded samples, wherein the padded samples are used to generate one or more OBMC regions;
deriving an original predictor of the current block from the fetched reference samples;
deriving an OBMC predictor for the current block by motion compensation using motion information of a neighboring block;
applying OBMC to the current block by blending the OBMC predictor with the original predictor of the current block; and
encoding or decoding the current block.
